(19) United States
(12) Patent Application Publication
(10) Pub. No.: US 2004/0214011 A1
(43) Pub. Date: Oct. 28, 2004

(54) Fabrication method and substrate structure of polysilicon thin-film transistor

(76) Inventors: Shih-Chang Chang, Hsinchu (TW); Yaw-Ming Tsai, Taichung (TW)

Correspondence Address: HARNESS, DICKEY & PIERCE, P.L.C., P.O. BOX 8910, RESTON, VA, 20195, US

(21) Appl. No.: 10/419,775

(22) Filed: Apr. 22, 2003

(51) Int. Cl. B32B 9/00

(52) U.S. Cl. 428/426; 428/446; 428/698; 428/336

(57) ABSTRACT

A fabrication method and substrate structure of polysilicon thin-film transistors uses a substrate structure that retards the temperature decreasing during annealing and crystallizing of the amorphous silicon so that the melted silicon has enough time to transform into larger polysilicon crystals with more uniform dimensions and a lower surface roughness.

### BACKGROUND OF THE INVENTION

1. Field of the Invention

The invention generally relates to fabrication and substrate structure of thin-film transistors, and particularly relates to a fabrication method and substrate structure of polysilicon thin-film transistors.

2. Related Art

Polysilicon thin-film transistors have the characteristics of high carrier mobility, low temperature sensitivity and better driving capabilities so as to be applicable to high-speed elements. A liquid crystal display composed of switch elements of polysilicon thin-film transistors has characteristics of fast display, high luminosity, driving and control circuits made on a same board, higher reliability and lower cost. Therefore, thin-film transistor (TFT) liquid crystal display has been a trend of development and manufacture.

When annealing amorphous silicon into polysilicon, the annealing temperature is higher than 600 degrees Celsius. For better crystallization, the annealing temperature has to be raised to 1200 to 1400 degrees Celsius so that a quartz substrate board has to be used. However, quartz substrates are expensive. Therefore, people use glass plates to replace quartz plates and require annealing processes in the order of 600 degrees Celsius. Some low temperature polysilicon manufacturing processes (LTPS) for fabricating polysilicon on low-melting glass substrates have been developed. Whatever an annealing process is used, the amorphous silicon (a-Si) film formed on the glass substrate has to be heated to a melting point so as to be melted and annealed then for transforming into a polysilicon structure. The process is taken below 600 degrees Celsius that will not damage the glass substrate. An insulated oxide layer id formed between the glass substrate and the amorphous silicon film. In order to prevent ions, such as sodium or kalium, in the glass substrate penetrating into the insulative oxide layer during heating and annealing, a silicon nitride layer is also formed on the glass substrate.

The performance of threshold voltage, field-effect mobility and driving current of a polysilicon thin-film transistor is determined by the crystal dimensions and structure of the polycrystalline silicon. For forming larger and more uniform polysilicon crystals, adequate time and energy are required for the silicon atoms to reallocate. Sony Corporation provides a new process disclosed in U.S. Pat. No. 5,219,786. The annealing process first preheats a glass substrate and the semiconductor layer at 600 degrees Celsius. Then, heats a portion of a small area of the semiconductor layer by a pulse of an excimer laser beam in one annealing cycle to a temperature higher than the preheating temperature and high enough to anneal the portion of the semiconductor layer. Since the semiconductor layer is preheated and the excimer laser beam needs only to raise the temperature of the semiconductor layer partially, the glass substrate will not be damaged. However, the process requires a fast heating device and an excimer laser generator in the heating device. The devices cost a lot and are not easy to be integrated with conventional facilities and processes.

Under cost consideration, to utilize the current facilities and to improve the polycilicon characteristics, such as larger crystals, more uniform crystal dimensions, and lower surface □ □ roughness, for fabricating polysilicon thin-film transistor liquid crystal displays becomes an important issue of process development.

### SUMMARY OF THE INVENTION

The object of the invention is to provide a fabrication method and substrate structure of polysilicon thin-film transistors. The method of the invention gives a substrate structure that retards the temperature decreasing during annealing and crystallizing of amorphous silicon so that the melted silicon has enough time to transform into larger polysilicon crystals with more uniform dimensions and a lower surface roughness.

A substrate structure for forming polysilicon thin-film transistor according to the invention includes a glass plate, a thermal retardant layer and an insulative oxide layer. An amorphous silicon film is placed on the insulative oxide layer for being transformed into polysilicon structure through heating, melting, annealing and crystalizing processes. In order to retard temperature decreasing during annealing, the thermal retardant layer in the substrate structure of the invention retards the thermal loss and makes the silicon atoms have adequate time and energy to reallocate and form into polysilicon crystals of larger and more uniform dimensions.

Similar to conventional fabrication process of thin-film transistors, the substrate structure of the invention also includes a silicon nitride layer formed on the surface of glass plate for preventing sodium or kalium ions penetrating into the insulative oxide layer during the heating process. Therefore, the substrate structure of the invention includes multiple layers of silicon oxide and low thermal conductivity materials for better thermal retardation.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a substrate structure of a first embodiment of the invention;

FIG. 2 is a substrate structure of a second embodiment of the invention; and

FIG. 3 is a substrate structure of a third embodiment of the invention.

### DETAILED DESCRIPTION OF THE INVENTION

The invention provides a fabrication method and substrate structure of polysilicon thin-film transistors. The method uses a substrate structure that retards temperature decreasing during annealing and crystallizing the amorphous silicon into polysilicon so that the melted silicon has enough time to transform into larger and more uniform crystals.

A substrate structure in the invention includes a thermal retardant layer made of low thermal conductivity materials of silicon nitride, silicon oxide, silicon nitric oxide or others. By applying the substrate structure, a fabrication process of polysilicon thin-film transistor according to the invention decreases the thermal loss of the substrate during annealing so that the melted silicon atoms have adequate time to crystallize. The crystallization is improved and the surface roughness of the polysilicon is decreased. Preferred embodiments of the invention are described below.

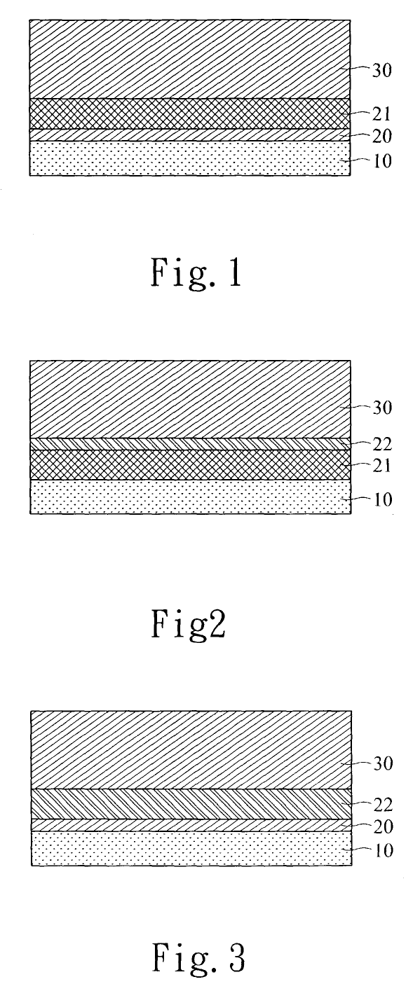

FIG. 1 shows a first embodiment of the invention. The substrate structure, from bottom to top, includes a glass plate 10, a silicon oxide (SiOx) layer 20, a silicon nitride (SiNx) layer 21 and an insulative oxide layer 30. In order to insulate, to prevent ion penetration from the glass plate 10 and to decrease thermal loss, the thickness of each layer has to be suitably controlled. For example, thickness of the silicon nitride layer 21 is about 500 angstroms; thickness of the insulative oxide layer 30 is about 1300 angstroms; and thickness of the silicon oxide layer 20 has to be larger than 200 angstroms.

FIG. 2 shows a second embodiment of the invention. The substrate structure, from bottom to top, includes a glass plate 10, a silicon nitride (SiNx) layer 21, a silicon nitric oxide (SiNxOx) layer 22 and an insulative oxide layer 30. Thickness of the silicon nitride layer 21 is about 500 angstroms; thickness of the insulative oxide layer 30 is about 1300 angstroms; and thickness of the silicon nitric oxide layer 22 has to be larger than 200 angstroms.

FIG. 3 shows a third embodiment of the invention. The substrate structure, from bottom to top, includes a glass plate 10, a silicon oxide (SiOx) layer 20, a silicon nitric oxide (SiNxOx) layer 22 and an insulative oxide layer 30. Thickness of the silicon nitric oxide layer 22 is about 500 angstroms; thickness of the insulative oxide layer 30 is about 1300 angstroms; and thickness of the silicon oxide layer 20 has to be larger than 200 angstroms.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A substrate structure applicable to a heating and annealing process of fabricating polysilicon thin-film transistors from an amorphous silicon film, comprising:
a glass plate;
a thermal retardant layer, formed on s surface of said glass plate, for retarding temperature decreasing after heating; and
an insulative oxide layer, for covering the surface of said thermal retardant layer and carrying said amorphous silicon film.

2. A substrate structure applicable to a fabrication process of polysilicon thin-film transistors according to claim 1 wherein thickness of said insulative oxide layer is around 1300 angstroms.

3. A substrate structure applicable to a fabrication process of polysilicon thin-film transistors according to claim 1 wherein said thermal retardant layer is composed of a silicon nitride layer and a silicon oxide layer.

4. A substrate structure applicable to a fabrication process of polysilicon thin-film transistors according to claim 3 wherein thickness of said silicon nitride layer is around 500 angstroms; thickness of said silicon oxide layer is larger than 200 angstroms.

5. A substrate structure applicable to a fabrication process of polysilicon thin-film transistors according to claim 1 wherein said thermal retardant layer is composed of a silicon nitride layer and a silicon nitric oxide layer.

6. A substrate structure applicable to a fabrication process of polysilicon thin-film transistors according to claim 5 wherein thickness of said silicon nitride layer is around 500 angstroms; thickness of said silicon nitric oxide layer is larger than 200 angstroms.

7. A substrate structure applicable to a fabrication process of polysilicon thin-film transistors according to claim 1 wherein said thermal retardant layer is composed of a silicon oxide layer and a silicon nitric oxide layer.

8. A substrate structure applicable to a fabrication process of polysilicon thin-film transistors according to claim 7 wherein thickness of said silicon nitric oxide layer is around 500 angstroms; thickness of said silicon oxide layer is larger than 200 angstroms.

9. A substrate structure applicable to a fabrication process of polysilicon thin-film transistors according to claim 1 wherein said thermal retardant layer is composed of multiple layers of silicon nitric oxide.

10. A substrate structure applicable to a fabrication process of polysilicon thin-film transistors according to claim 1 wherein said thermal retardant layer is made of a low thermal conductivity material.

11. A method for fabricating polysilicon thin-film transistors from an amorphous silicon film through a heating and annealing process, characterized in: placing said amorphous silicon film on a substrate composed of a glass plate, a thermal retardant layer, and an insulative oxide layer; said amorphous silicon film is placed on surface of said insulative oxide layer so that, during said annealing process, said thermal retardant layer retards temperature decrease of said substrate and provides adequate time for crystallization of said polysilicon.

12. A method for fabricating polysilicon thin-film transistors according to claim 11 wherein thickness of said insulative oxide layer is around 1300 angstroms.

13. A method for fabricating polysilicon thin-film transistors according to claim 11 wherein said thermal retardant layer is composed of a silicon nitride layer and a silicon oxide layer.

14. A method for fabricating polysilicon thin-film transistors according to claim 13 wherein thickness of said silicon nitride layer is around 500 angstroms; thickness of said silicon oxide layer is larger than 200 angstroms.

15. A method for fabricating polysilicon thin-film transistors according to claim 11 wherein said thermal retardant layer is composed of a silicon nitride layer and a silicon nitric oxide layer.

16. A method for fabricating polysilicon thin-film transistors according to claim 15 wherein thickness of said silicon nitride layer is around 500 angstroms; thickness of said silicon nitric oxide layer is larger than 200 angstroms.

17. A method for fabricating polysilicon thin-film transistors according to claim 11 wherein said thermal retardant layer is composed of a silicon oxide layer and a silicon nitric oxide layer.

18. A method for fabricating polysilicon thin-film transistors according to claim 17 wherein thickness of said silicon nitric oxide layer is around 500 angstroms; thickness of said silicon oxide layer is larger than 200 angstroms.

19. A method for fabricating polysilicon thin-film transistors according to claim 11 wherein said thermal retardant layer is composed of multiple layers of silicon nitric oxide.

20. A method for fabricating polysilicon thin-film transistors according to claim 11 wherein said thermal retardant layer is made of a low thermal conductivity material.
